(19) United States
(12) Patent Application Publication
(10) Pub. No.: US 2004/0124792 A1
(43) Pub. Date: Jul. 1, 2004

(54) Directional luminaire

(76) Inventors: Jerry F. Fischer, West Chester, OH (US); Larry A. Akers, Clarksville, OH (US)

Correspondence Address: DANIEL B. RUNK, 1400 PROVIDENT TOWER, ONE EAST FOURTH STREET, CINCINNATI, OH, 45202, US

(21) Appl. No.: 10/329,808

(22) Filed: Dec. 26, 2002

(51) Int. Cl. H05B 39/06

(52) U.S. Cl. 315/362

(57) ABSTRACT

A directional luminaire comprises a door frame and lamp shroud having a lampholder socket attached to a luminaire support structure. The luminaire is wired, either directly or indirectly, to provide an electrical connection to a lampholder socket configured to receive a lamp. The lamp shroud has an opening from which the light output is directed. Further, the rim edge of the lamp shroud and retaining lip of the door frame interact to permit substantially complete rotation of the lamp shroud and lamp.

### FIELD OF THE INVENTION

This invention relates generally to luminaires and more particularly to luminaires providing directional lighting.

### BACKGROUND OF THE INVENTION

Luminaires are typically mounted on or within a support structure, such as a ceiling, wall, soffit, canopy structure or building exterior. They are used in many commercial and consumer applications to illuminate particular areas of a site.

Luminaires of currently existing designs are typically mounted on their support structures either by direct attachment to the structure or by creating an opening and installing the recessed luminaire into the opening. A drawback associated with many existing luminaires is that the lamp is mounted in a fixed position on or within the support structure. This prohibits redirection of the light emanating from the lamp toward specific, desired areas below the light. Although lenses can be used to direct the light toward a particular area and focus the light output downward, a substantial portion of the luminous output of the lamp is nevertheless emitted in other directions. Further, although a particular lens could be designed to direct light for a singular purpose, any change in the area below the light would require difficult and costly adjustment of the light to adapt to the new area.

Some existing luminaires permit movement of the luminare body to direct the light output, most notably track lighting. However, existing luminaires are not designed to withstand outside environments, such as weather and insects. Further, many have limitations in the rotational range of the lamps and cannot be easily locked into place.

Another common problem is the amount of electricity consumed by the lamp and the complexity of the lamp's electrical system. While a variety of types of lighting lamps can be used, including common fluorescent and incandescent lamps, luminaires in commercial applications often use high intensity discharge (HID) lamps to provide the desired level of lighting. The use of HID light sources can have many drawbacks. HID light sources are regulated by control gear, which may include a ballast alone or in combination with other components such as capacitors, igniters, or other such equipment. This control gear may be as large as or larger than the lamp itself. Further, the lamp and control gear are frequently contained within a box-like housing, which must be mounted to the support structure. HID lights sources also use more electricity than lighting alternatives.

A further drawback associated with existing luminaires is the difficulty in directing the light output toward the intended area thereby necessitating use of a larger lamp, such as a HID lamp, than would otherwise be required. As the lens cannot efficiently direct the light to specific areas, much of the light is scattered toward unintended local and distant destinations. This scattering results in light pollution issues ranging from the disturbance of neighbors to interference of night sky viewing.

Thus, there is a substantial need for a luminaire that may be easily and quickly adjusted to direct light toward a particular target area without scattering light to unintended areas. Further, there is a significant need for a luminaire that capable of using a smaller lamp and consuming less electricity in its operation while providing the same degree of illumination.

### SUMMARY OF THE INVENTION

The present invention provides a luminaire which overcomes drawbacks associated with the currently existing luminaires. More specifically, the luminaire comprises a door frame attached to a luminaire support structure, a rotatable lamp shroud disposed within the door frame and a lampholder socket disposed within the lamp shroud. The door frame is typically disposed on the underside of the support structure, either by being attached directly to the structure or supported by other elements of the structure located above the structure. The lamp shroud is opaque and designed to avoid emission of any light from the shroud except through an opening. The lampholder socket is disposed in such a location as to direct the light from the lamp in the socket through the opening in the lamp shroud, either directly or via use of reflectors. The lampholder socket is electrically connected to a power source either directly or through the use of a socket adapter having a male end that can be inserted into an existing lampholder socket disposed near or above the door frame. The lamp is held in place using retaining clips and the lamp itself can be directed at different angles relative to the opening by using tabs to lift the lamp if desired. Further, the opening is typically covered with a transparent or translucent material such as a glass or plastic lens to shield the interior environment of the shroud from the outside environment and a baffle is also disposed next to the lens material to reduce scattering of the light. Optionally, a reflector can be disposed adjacent to the lamp to further increase the efficient direction and output of the lamp.

The rim edge of the lamp shroud extends beyond the retaining lip of the door frame, thereby permitting rotation of the shroud within the frame. Stops are used on the shroud and door frame to restrict rotation of the shroud to a single 360° rotation thereby avoiding the tangling of the electrical connections while still providing complete rotational movement of the luminaire. The shroud rim edge and frame retaining lip also use a locking mechanism to prevent rotation of the shroud after it is positioned in the optimal position. In one embodiment the locking mechanism is a clamp which can be loosened or tightened by turning a bolt on the bottom of the shroud.

Further to another aspect of the present invention, the door frame is attached to the support structure via attachment mechanisms. One common mechanism for attachment includes hinges at one end and a spring clasp attached at a second end, opposite the first end, permitting the door frame to swing between an open position and a closed position. The pivoting door frame permits easy replacement of the lamp and access to the interior of the shroud.

The present invention can also be retrofit to existing luminaires. For an old luminaire with a similar structure, the old door assembly can be removed by prying the door hinge keepers off and removing the existing door from the luminaire housing. The new door frame and lamp shroud are then installed on the hinges and new hinge keeps are installed. For an old luminaire with a more traditional structure, the lens or luminaire bowl can be removed and appropriate attachment mechanisms can be used to attach the door frame to the structure, such as hinge receivers or fasteners that directly attach the door frame to the structure. In either case, the lamp and lampholder socket can be electrically connected to the existing luminaire either by using a male adapter to connect the lampholder socket to the pre-existing luminaire socket or simply directly wiring the lampholder socket into the pre-existing electrical circuit. The connection between the lampholder socket and its electrical source includes wiring of sufficient length to allow 360° rotation of the shroud.

By virtue of the foregoing, there is thus provided a luminaire that permits easy and quick direction of its light output toward a particular area. Additionally, the light output of the luminaire can be easily redirected to another target area through rotation of the luminaire shroud. Additionally, the efficiencies of the luminaire permit use of a lower wattage or smaller type of lamp, thereby reducing usage of electricity while preserving usable light output. Further, the luminaire reduces local and distant light pollution. Still further, the luminaire is adapted to enable a single individual to quickly and easily replace the lamp, access the shroud interior, and redirect the luminaire.

These and other objects and advantages of the present invention shall become apparent from the accompanying drawings and the detailed description thereof.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the principles of the invention.

FIG. 1 is a partial side perspective of the luminaire in accordance with the principles of the present invention.

FIG. 2 is a top perspective view of a portion of the shroud.

FIG. 3 is a bottom perspective view of the luminaire.

FIG. 4 is an elevation view showing a lamp in the shroud.

FIG. 5 is a top perspective view of a portion of the rim edge of the shroud.

FIG. 6 is an elevation view showing the opening of the door frame and shroud portion of the luminaire in an open position away from a luminaire housing.

### DETAILED DESCRIPTION OF THE DRAWINGS

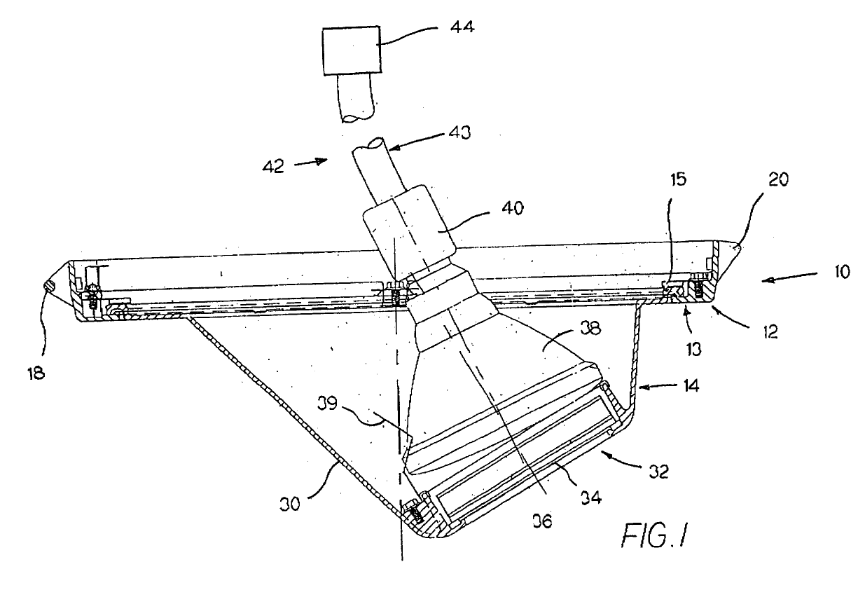

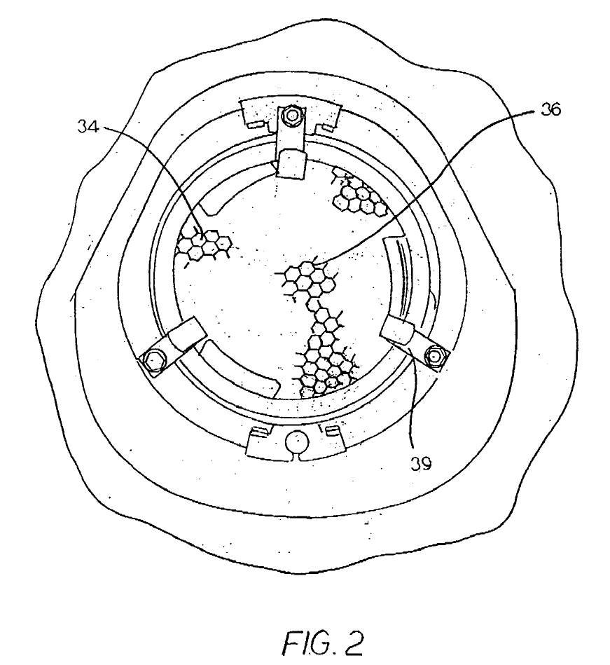

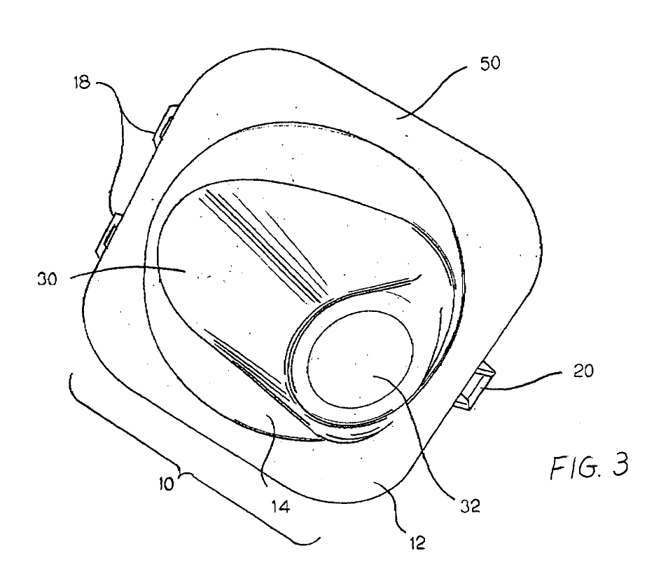

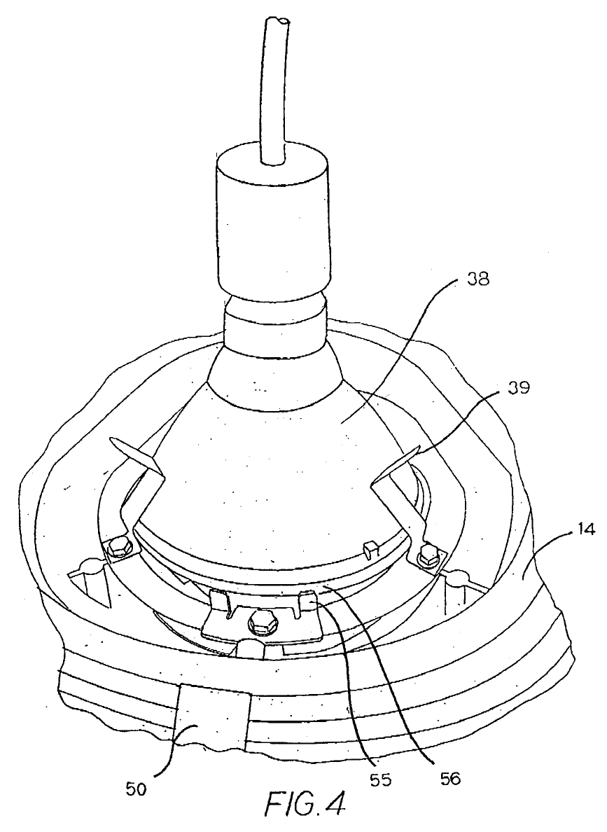

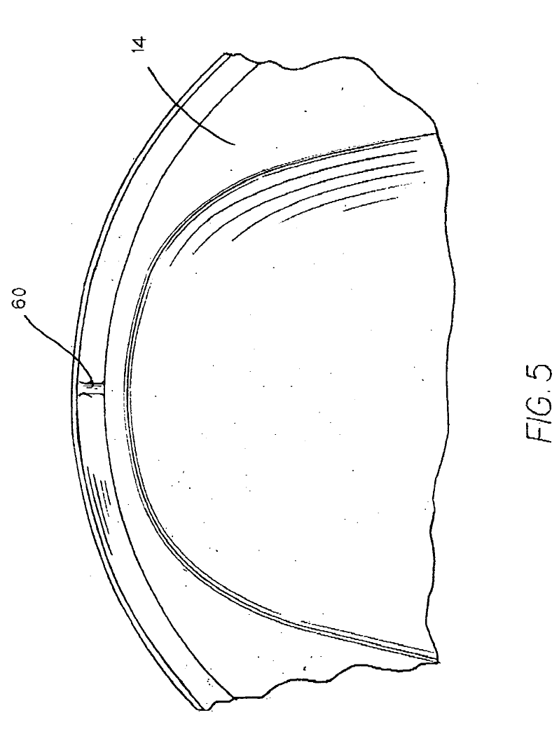

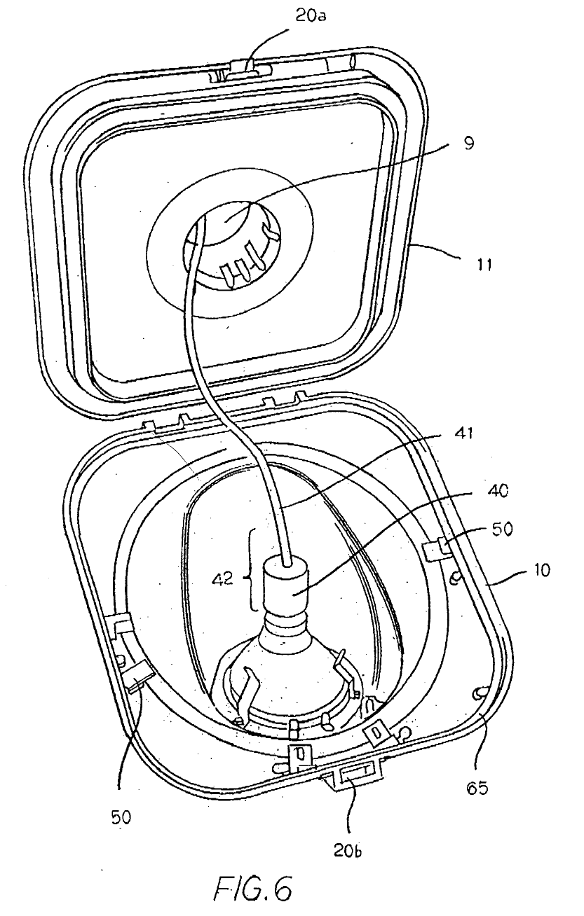

The directional luminaire 10, as depicted in FIG. 1, comprises a door frame 12 and lamp shroud 14. The rim edge 15 of the lamp shroud 14 extends over the retaining lip 13 of the door frame 12 thereby permitting rotation of the lamp shroud 14 within the door frame 12. A shroud stop 60 as shown in FIG. 5 and door frame stop interact to limit rotation of the shroud to a single 360° rotation. The shroud is fastened into a particular position of rotation by tightening a lock nut and clamp assembly 50 as shown in FIGS. 3 and 6. The entire directional luminaire 10 is connected to the support structure with attachment mechanisms, such as the illustrated hinge 18 on one side of the luminaire 10 and a spring clasp 20 at the other end. The spring clasp, as shown in FIG. 6, consists of a receiving flexible clasp 20a and a clasp bar 20b that fits into and is held by the clasp 20a. The shroud 14 comprises a rotatable shroud body 30 with an opening 32. The opening is fit with a lens 34, and a baffle 36 which sits atop the lens 34 as shown in FIG. 2. A lamp 38 is located above the opening 32, lens 34 and baffle 36 and is held in place via lamp retaining clips 39. The lamp 38 as shown is an incandescent lamp, but could be any type of lamp, including a HID, fluorescent or incandescent lamp. The lamp 38 can be tilted at an angle relative to the opening 32 by raising and placing the lamp edge 56 on tabs 55 that are located at the edge of the opening 32 as depicted in FIG. 4. The end of the lamp 38 is received by a first lamp socket 40 which is connected to a second lamp socket 41 via an adapter 42. The adapter 42 has electrical wiring 43 connected on one end to the first lamp socket 40 and on the other end a socket adapter 44. The socket adapter 42 is received by the second lamp socket 41. The second lamp socket 41 is connected to an electrical power source.

As depicted in FIG. 6, the directional luminaire assembly 10 is shown coupled with a luminare housing structure 11. The door frame 12 is lined with weatherstripping 65 to prevent exterior elements from entering the luminaire 10. The adapter 42 consists of a first lamp socket 40 and electrical wiring 41 that passes through a housing opening 9 and is directly wired into a electrical power source accessible through the housing opening 9.

While the present invention has been illustrated by description of a several embodiments which have been described in detail, it is not the intention of the applicant to restrict or in any way limit the scope of the appended claims to such detail. Additional advantages will readily appear to those skilled in the art. Thus, the invention in its broadest aspects is not limited to the specific details, representative apparatus and method, and illustrative examples shown and described. Accordingly, departures may be made from the details without departing from the spirit or scope of applicant's general inventive concept.

What is claimed is:

1. A luminaire adapted for directional adjustment, comprising:
a luminaire support structure;
a door frame attached to said structure;
a rotatable lamp shroud attached to said door frame wherein said lamp shroud has at least one opening; and
a lamp socket within said lamp shroud is sized to received the base of a lamp, said lamp socket being electrically connected to a power source and having an electrical contact and being electrically connectable to the base of a lamp when the lamp base is inserted therein.

2. The luminaire of claim 1 wherein said lamp socket and said lamp are directed toward said opening.

3. The luminaire of claim 2 wherein said opening is covered by a lens.

4. The luminaire of claim 3 wherein a baffle is located on top of said lens inside said lamp shroud.

5. The luminaire of claim 2 wherein the retaining lip of said door frame is formed with a recessed groove to receive the rim edge of said shroud which is formed with a groove of substantially similar dimensions to that of said door frame.

6. The luminaire of claim 5 wherein said groove of said rim edge is formed with a projection to limit rotation of said lamp shroud within said door frame to a single revolution.

7. The luminaire of claim 5 having one or more clamping mechanisms with a top clamp portion contacting the rim edge of said lamp shroud and a bottom portion comprising a screw extending from beneath said door frame through a threaded opening in said top clamp portion, wherein upon tightening of said screw said clamping mechanisms press said shroud and said door frame together and restrict movement of the coupled shroud and door frame.

8. The luminaire of claim 4 wherein lamp lifting tabs are attached to said shroud, said lens or said baffle in a position substantially adjacent to said opening.

9. The luminaire of claim 2 wherein said opening is not perpendicular to said structure.

10. The luminaire of claim 2 wherein said structure is a luminaire housing attached to a canopy.

11. The luminaire of claim 2 wherein said lamp socket is connected to a second lamp socket in said structure with an adapter.

12. The luminaire of claim 11 wherein said adapter is a wire connector having a first end electrically attached to said lamp socket and a second end electrically attached to a socket adapter for said second lamp socket.

13. The luminaire of claim 2 wherein one side of said door frame is attached to said structure with hinges and the opposite side of said door frame is attached to said structure with a flexible clasp mechanism.

14. The luminaire of claim 3 wherein said lamp is held in position by lamp retaining clips that are attached in a position substantially adjacent to said opening, said lens or said baffle.

15. The luminaire of claim 1 wherein a reflector is placed above said lamp.

16. The luminaire of claim 1 wherein one or more reflectors are placed within said shroud and direct the light output from said lamp out of said opening.

17. The luminare of claim 16 wherein said lamp is positioned in a substantially vertical position within said shroud and one or more reflectors surround said lamp and direct the light output from said lamp out of said opening.

18. A method of installing a retrofit directional luminaire assembly in an existing luminaire having a door frame attached to a support structure, a rotatable lamp shroud attached to said door frame and lamp socket disposed within said lamp shroud sized to receive a lamp, comprising:
removing an existing door assembly from the support structure to expose the interior of the luminaire housing;
removing any lamp and reflector from said structure;
providing a door frame having a lamp shroud with at least one opening disposed therein;
providing a lamp socket within said lamp shroud sized to receive the base of a lamp, said lamp socket being electrically connected to an electrical power source and being electrically connectable to the base of a lamp when the lamp base is inserted therein;
providing a lens within said opening that encloses said shroud;
engaging the pivot member on the flange surrounding said door frame for removably suspending the panel in a substantially vertical, inoperative position;
coupling a set of electrical leads from the power source to said lamp socket;
pivoting said door frame to a horizontal, operative position whereby said door frame substantially closes against said structure; and
securing said door frame in the horizontal, operative position.

19. The method of claim 18 further comprising the step of providing a reflector about the light-emitting section of said lamp for directing light emitted from said lamp through said opening.

20. A method of installing a retrofit directional luminaire assembly in an existing luminaire housing having door frame attached to a support structure, a rotatable lamp shroud attached to said door frame and lamp socket disposed within said lamp shroud sized to receive a lamp, comprising:
removing an existing door assembly from the luminaire support structure to expose the interior of the housing;
removing any lamp and reflector from said structure;
providing a door frame having a lamp shroud with at least one opening disposed therein;
providing a lamp socket within said lamp shroud sized to received the base of a lamp, said lamp socket having an electrical contact being connected to an electrical power source and being electrically connectable to the base of a lamp when the lamp base is inserted therein;
providing a lens within said opening for enclosing said shroud;
engaging the pivot member on the flange surrounding said door frame for removably suspending the panel in a substantially vertical, inoperative position;
coupling the original housing lamp socket to said lamp socket using an adapter;
pivoting said door frame to a horizontal, operative position whereby said door frame substantially closes against said structure; and
securing said door frame in the horizontal, operative position.

21. The method of claim 20 further comprising providing a reflector about the light-emitting section of said lamp for directing light emitted from said lamp through said opening.

22. A method of installing a luminaire assembly having a door frame attached to a luminaire support structure, a rotatable lamp shroud attached to said door frame and lamp socket disposed within said lamp shroud sized to receive a lamp, having a housing having a temporary retainer and an electrical connection comprising:
inserting the housing of the light fixture to a horizontal support structure with said housing inserted from below said structure upwardly into an opening in said structure;
engaging said housing with the temporary retainer on said structure;
holding said housing in said opening with said temporary retainer during installation of said luminaire;
coupling the electrical connection on said lamp socket to an electrical power source;
fixedly securing said housing to said structure from above said panel after said engaging and said holding steps;
providing a door frame having a lamp shroud with at least one opening disposed therein;
providing a lamp socket within said lamp shroud sized to received the base of a lamp, said lamp socket having an electrical contact and being electrically connectable to the base of a lamp when the lamp base is inserted therein;
providing a lens within said opening for enclosing said shroud;
engaging the pivot member on the flange surrounding said door frame for removably suspending said door frame in a substantially vertical, inoperative position;
coupling a set of electrical leads from the power source to said lamp socket;
pivoting said door frame to a horizontal, operative position whereby said door frame substantially closes against said structure; and
securing said door frame in the horizontal, operative position.

23. The method of claim 22 further comprising forming said opening in said structure prior to inserting said housing therein.

24. The method of claim 22 wherein said housing is solely held by said temporary retainer after said holding step and prior to said fixedly securing step.
